(19) United States
(12) Patent Application Publication
(10) Pub. No.: US 2013/0122882 A1
(43) Pub. Date: May 16, 2013

(54) AUTOMATED PROVISIONING OF CELLPHONE PLANS TRIGGERED BY MOBILE DEVICE MANAGEMENT SYSTEM ALERTS AND USAGE THRESHOLDS

(71) Applicants: Labhesh Patel, (US); Sanjeev Kumar, (US)

(72) Inventors: Labhesh Patel, (US); Sanjeev Kumar, (US)

(21) Appl. No.: 13/296,225

(22) Filed: Nov. 14, 2011

(51) Int. Cl. H04W 24/00

(52) U.S. Cl. 455/418

(57) ABSTRACT

Disclosed is a method for tracking a wireless communication plan and plan usage to control access costs for a mobile communication device having a resident mobile device management agent comprising: determining a geographic location for the mobile communication device; if the geographic location is determined to be in a first wireless connection network, automatically provisioning a first wireless communication plan for the mobile communication device; and if the geographic location is determined to be in a second wireless connection network, automatically provisioning a second wireless communication plan for the mobile communication device.

### CROSS REFERENCE TO RELATED APPLICATION

The present Application is related to Provisional Patent Applications: (i) entitled “Hybrid approach to usage monitoring using mobile apps and online account,” filed 15 Nov. 2010 and assigned filing No. 61/456,907; (ii) entitled “Cellphone usage analytics and plan recommendation,” filed 15 Nov. 2010 and assigned filing No. 61/456,911; and (iii) entitled “Cellphone usage monitoring, alerting, and analytics for parents,” filed 15 Nov. 2010 and assigned filing No. 61/456,912; all incorporated herein by reference in their entireties.

### FIELD OF THE INVENTION

This invention relates to mobile communication devices and, in particular, to a mobile communication device that functions to continually track a wireless communication plan and plan usage to keep communication access costs to a minimum.

### BACKGROUND OF THE INVENTION

By some accounts, as many as 80% of cell phone bills may have one or more billing errors. These billing errors can result either from negligence on part of the cell phone providers, and/or negligence on the part of the cell phone users.

By way of example, one cell phone user moved from San Francisco to Sunnyvale, Calif. and changed the billing address using the wireless provider website. Although Sunnyvale wireless charges incurred substantially less in local taxes, in comparison to the local tax rates in San Francisco, subsequent wireless statements continued to charge the user San Francisco tax rates. The requested change had not been made per the online request as it was the policy of the wireless provider that the user had to call the wireless provider to notify the billing personnel of the changed place of use before the wireless billing would reflect the change in residence.

In another example, it was reported that a national wireless provider had included “mystery fees” in billing invoices sent to account holders. Upon receiving complaints about the charges, the wireless charger agreed to refund account holders for the extra charges.

It is also appreciated that a wireless provider may charge excessive fees when the user of a cell phone roams outside a home service area. In a reported case, an aid worker using a cell phone in Haiti was presented with an invoice for thousands of dollars, after return to the United States, because of international roaming charges that were incurred. Unfortunately, the cell phone user may be unaware of these excessive fees until a billing invoice is sent out, at a later date. Often, user roaming data is substantially delayed so that, even if a cell phone user dutifully checks the online billing statement, the roaming charges may not be shown.

Moreover, the current state of the art does not provide a method by which a cell phone user can audit cell phone call activity being invoiced by a wireless provider. By way of example, if the wireless provider usage or billing data shows that a one minute call was placed on a particular date, the cell phone user does not have any way of knowing whether the call was almost sixty seconds long or only about one second long. Many wireless providers state that a call duration is rounded down to the closest minute for invoicing, but there is no way of verifying that this is being done.

What is needed is an automated method for continually tracking the geographic location of a cell phone and making appropriate changes to the associated wireless communication plan in response to the location changes so as to keep wireless communication access costs to a minimum for the cell phone user.

### BRIEF SUMMARY OF THE INVENTION

There is disclosed a mobile device management agent, residing on a mobile device, the agent reporting location and usage information to an auto provisioning software product, the software product residing on the mobile device or in a remote server. The auto-provisioning software product is configured to selectively modify wireless communication usage plan changes for the mobile device, the plan modifications selected so as to ensure that the mobile device is provided with an appropriate wireless communication usage plan by which cellular services may be provided to the mobile device at reduced cost.

In one aspect of the present invention, a method for tracking a wireless communication plan and plan usage to control access costs for a mobile communication device having a resident mobile device management agent comprises: determining a geographic location for the mobile communication device; if the geographic location is determined to be in a first wireless connection network, automatically provisioning a first wireless communication plan for the mobile communication device; and if the geographic location is determined to be in a second wireless connection network, automatically provisioning a second wireless communication plan for the mobile communication device.

In another aspect of the present invention, a mobile communication device that functions to continually track a wireless communication plan and plan usage comprises: a mobile device management agent, the mobile device management agent functioning to control access between the mobile communication device and a wireless communication network; an application programming interface in communication with the mobile management agent; and an auto-provisioning software application in communication with the mobile management agent via the application programming interface for automatically provisioning a wireless communication plan for the wireless communication device based on at least one of a real-time geographic location of the mobile communication device and a current usage history for the mobile communication device.

In another aspect of the present invention, a computer product, tangibly embodied in a non-transitory computer-readable medium, for tracking a wireless communication plan to control access costs for a mobile communication device, the computer program product including instructions for causing a processor to execute a method comprising: detecting the mobile communication device; accessing a global positioning system to determine a real-time geographic location for the mobile communication device; if the geographic location is determined to be in a first wireless connection network, selecting a first wireless communication plan for the mobile communication device; and if the geographic location is determined to be in a second wireless connection network, selecting a second wireless communication plan for the mobile communication device.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying drawings, in which:

FIG. 1 is a diagrammatical view of wireless global roaming system in which an automated provisioning software application is used in a mobile communication device for provisioning of wireless communication plans, in accordance with the present invention;

FIG. 2 is a diagrammatical view of wireless global roaming system in which an automated provisioning software application, resident in a remote monitoring server, is used for provisioning of wireless communication plans, in accordance with the present invention;

FIG. 3 is a flow diagram illustrating operation of the automated provisioning applications of FIGS. 1 and 2;

FIG. 4 is a flow diagram illustrating the automated provisioning application of FIGS. 1 and 2 operating to revert to an original wireless communication plan of a user; and

FIG. 5 is a flow diagram illustrating an alternate operation of the automated provisioning applications of FIGS. 1 and 2.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims. Those skilled in the art will appreciate that the conception upon which the disclosure below is based may readily be utilized as a basis for designing other products. For example, the mobile communication device disclosed herein may comprise a cell phone, a personal data assistant, or other electronic display device having a touch screen interface for inputting data and commands, with functionality as disclosed and claimed, without departing from the spirit of the invention.

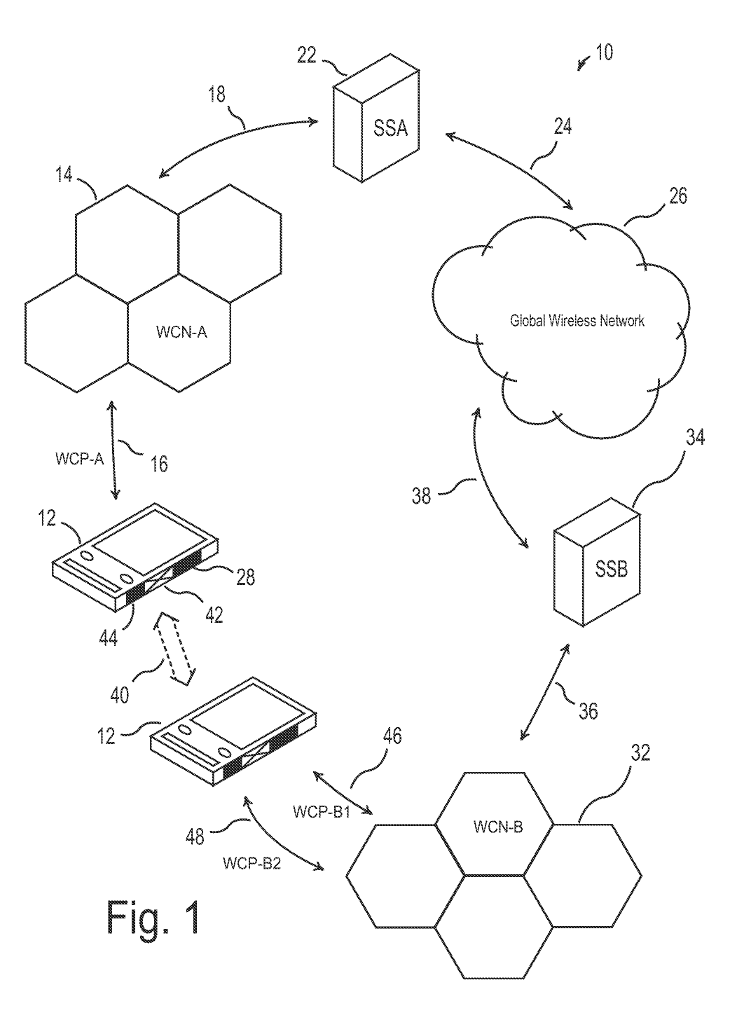

There is shown in FIG. 1 a diagrammatical illustration of a wireless global roaming system 10 in which a user operates a mobile communication device 12 to access a local Wireless Communication Network A (WCN-A) 14 via a Wireless Communication Plan A (WCP-A) 16. The Wireless Communication Network A 14 communicates with a switching server A 22 maintained by a local provider via a network link A 18. A Mobile Device Management (MDM) agent 28 may be provided in the mobile communication device 12, where the MDM agent 28 functions to provide location and usage information to an auto-provisioning software application, described below. The MDM agent 28 may also control the access of any user-initiated communication (e.g., voice call, SMS, or other application that uses data connectivity) to the Wireless Communication Network A 14, but might not function to provision wireless communication plans.

The switching server A 22 may communicate with a global wireless network 26 via a server A communication link 24. The user of the mobile communication device 12 can thus access the global wireless network 26 to communicate with a user in a remote wireless network, exemplified by a Wireless Communication Network B (WCN-B) 32. As can be appreciated by one skilled in the relevant art, the Wireless Communication Network B 32 may communicate with a switching server B 34 via a network link B 36, and the switching server B 34 may communicate with the global wireless network 26 via a server B communication link 38.

In an exemplary embodiment, a modest monthly access fee may be paid for a Wireless Communication Plan A (WCP-A) 16 that enables the user to communicate with other mobile communication device users via the Wireless Communication Network A 14. If the user leaves the geographic area in which the Wireless Communication Network A 14 can be accessed with the mobile communication device 12, such as may result from an international business trip, the mobile communication device 12 may be able to maintain wireless communications by accessing the Wireless Communication Network B 32 via a roaming Wireless Communication Plan B1 (WCP-B1) 46. The cost for connect time expended under the roaming Wireless Communication Plan B1 46 is typically greater than the cost for a similar connect time under the Wireless Communication Plan A 16.

If the mobile communication device 12 was provided to the user by an employer, there may be certain administrative policies in effect regarding use of the mobile communication device 12 when the employee requires access to a roaming wireless communication plan while on a travel assignment. Such an administrative policy, for example, may not allow use of the mobile communication device 12 in a roaming area, or may allow limited use in such areas, or may allow roaming charges to accrue after successfully soliciting ad hoc approval from an employee supervisor.

Accordingly, the employer would prefer to keep wireless communication costs at a minimum by administratively limiting user charges that could be incurred by having continual access to the relatively expensive Wireless Communication Plan B1 42. In accordance with the present invention, the mobile communication device 12 may include an auto-provisioning (AP) software application 44 that functions as automated administrator and may automatically provision, for example, an alternative Wireless Communication Plan B2 (WCP-B2) 48 in place of the more costly Wireless Communication Plan B1 46.

The auto-provisioning software application 44 thus responds to information provided by the MDM agent 28 by automatically restricting operation of the mobile communication device 12 in accordance with the pre-established administrative policies. The MDM agent 28 accepts and executes commands from the auto-provisioning software application 44 such as, for example, terminating all user-initiated communication (e.g., blocking all calls, messaging, and data access), but does not function to provision wireless communication plans.

The MDM agent 28 may function to send other device information to the auto-provisioning software application 44, for example, the real-time geographic location of the mobile communication device 12 or the current call history or other usage information of the mobile communication device 12. Communication between the auto-provisioning software application 44 and the MDM agent 28 may be enabled through an application programming interface (API) 42 resident in the mobile communication device 12. Accordingly, provisioning activity may be triggered by alerts and mobile device usage information sent by the MDM agent 28 to the auto-provisioning software application 44, as described in greater detail below.

One purpose of the auto-provisioning software application 44 is to keep track of administrative policies stating when wireless communication plan changes may be made, and when a plan change is to revert back to an original setting. The auto-provisioning software application 44 may function by logging into a wireless carrier web portal, for example, to interact with web site information and determine the current plans available to the mobile communication device 12.

The auto-provisioning software application 44 may then communicate with the responsible wireless communication provider to make a requested change to the current wireless communication plan in force, and may select an effective date and time of a change to the plan. Further, depending on the usage policy of the particular wireless provider, the auto-provisioning software application 44 can make the wireless communication plan change effective: (i) retroactively, from the start of a current billing cycle, or (ii) from a future date, such as the start of a subsequent billing cycle, or (iii) from the date of the change request.

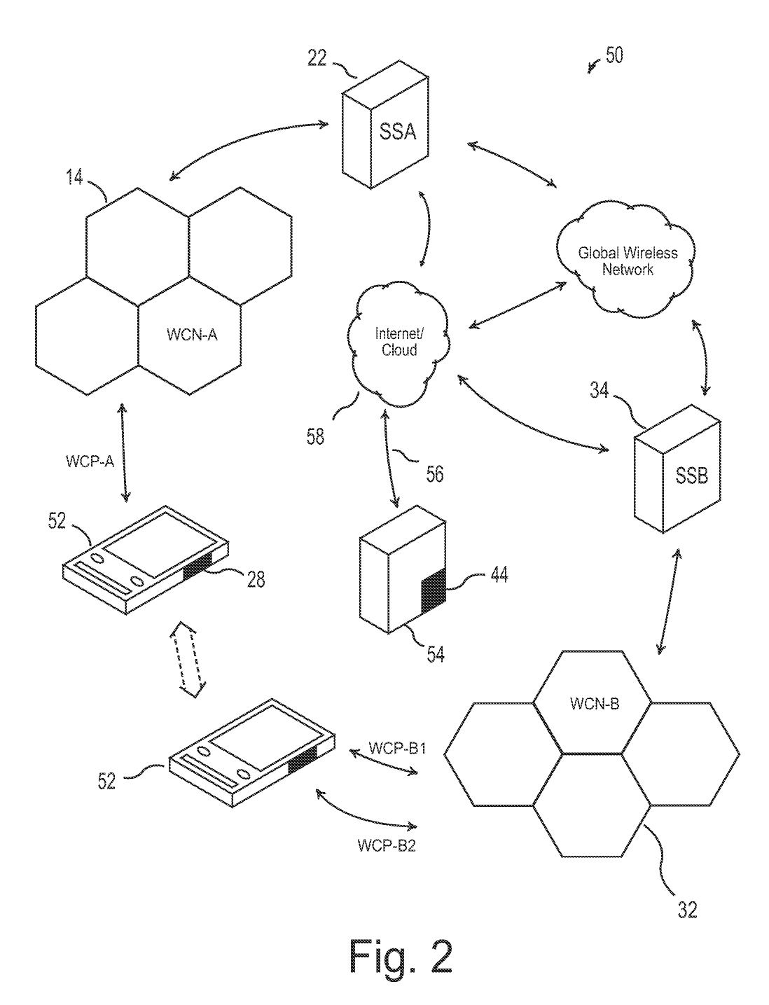

In an alternative embodiment of a wireless global roaming system 50, shown in FIG. 2, the auto-provisioning software application 44 may be resident in a monitoring server 54. The user may access the Wireless Communication Network A 14 with a mobile communication device 52 having the MDM agent 28. An internet link 56 may be provided to enable communication between the monitoring server 54, the switching server A 22, and the switching server B 34, where the communication flows via the Internet or cloud 58. Communication is thus enabled between the MDM agent 28 and the auto-provisioning software application 44, for example, whether the mobile communication device 52 is in the Wireless Communication Network A 14, or in the Wireless Communication Network B 32.

It can be appreciated by one skilled in the art that there may be one or more layers in between the auto-provisioning software application 44 and the MDM agent 28. In one example, the MDM agent 28 may communicate with an MDM server (not shown in figures) to send device location and usage information to the auto-provisioning software application 44. The MDM agent 28 may further function to receive commands from the MDM server to, for example, stop user-initiated communication, to display an alert to the user of the mobile communication device, and to control other such communication functions.

The auto-provisioning software application 44 may communicate with the MDM server to obtain mobile device location and mobile device usage information, and transmit instructions to the MDM server to control user communication, display alerts, etc. It should be apparent to one skilled in the art that adding one or much such layers lies within the scope of the current invention. The MDM agent 28 and any associated MDM server layers together comprise an MDM solution with which the auto-provisioning software application 44 communicates for controlling auto-provisioning activities.

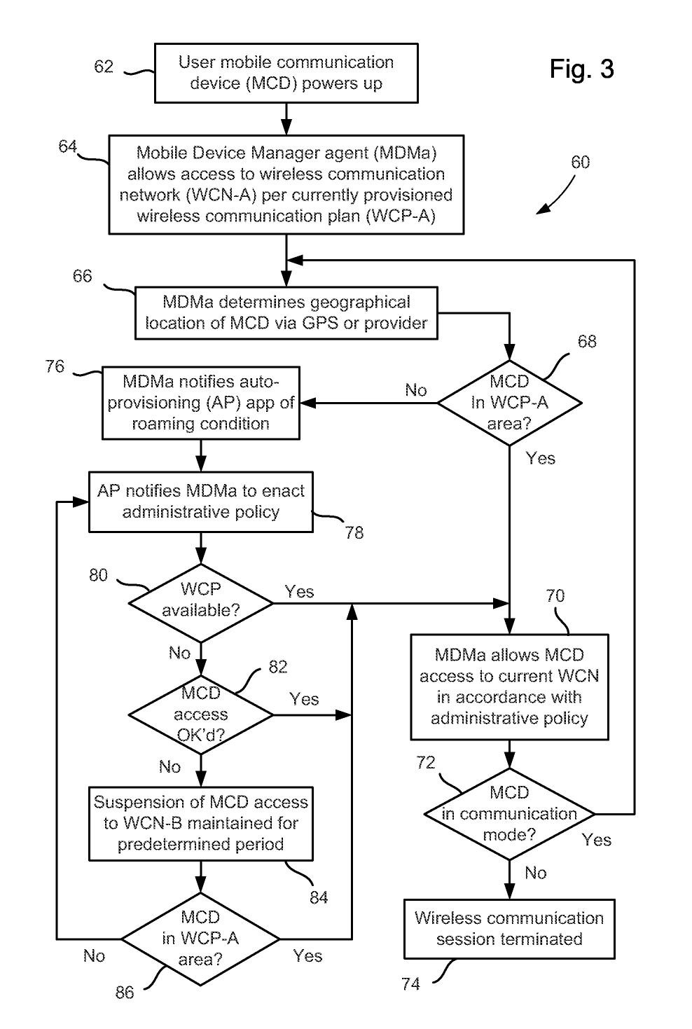

User operation of the mobile communication device 12 in the wireless global roaming system 10, and operation of the mobile communication device 52 in the wireless global roaming system 50, can be described with additional reference to a flow diagram 60, shown in FIG. 3. The user powers up the mobile communication device, at step 62, if the mobile communication device was not already powered up. The mobile communication device connects to the Wireless Communication Network A 14 in accordance with the current wireless communication plan A 16, at step 64.

The current, real-time geographic location of the mobile communication device is determined, at step 66, after the auto-provisioning software application 44 has derived geographic coordinates for the mobile communication device. This may be accomplished by using the MDM agent 28 to access a Global Positioning System (not shown), or to access a database of cellular towers to determine the real-time geographic location of the mobile communication device, or by obtaining the current geographic coordinates of the mobile communication device from the provider of the wireless communication system with which the mobile communication device is linked.

In an exemplary embodiment, the auto-provisioning software application 44 may continually access or utilize an updated geographic location of the mobile communication device to determine whether or not the mobile communication device has remained in the geographic area served by the current wireless communication plan A 16, at decision block 68. In an alternative embodiment, the auto-provisioning software application 44 may be notified only when there is a change in geographic location of the mobile communication device.

For example, once the user travels to a different country, the MDM agent 28 may notify the auto-provisioning software application 44 about the new geographic location. If the user travels to yet another country, then the MDMA agent 28 may notify the user about the new geographic location of the mobile communication device. Similarly, if the user returns to a home calling area, then the MDMA agent 28 may notify the auto-provisioning software application 44 accordingly.

If the mobile communication device is in the home service area of the wireless communication plan A 16, the mobile communication device may be allowed to continue accessing the wireless communication network A for a predetermined amount of time, for example, fifteen minutes, at step 70. That is, when the mobile communication device is determined to be in a first, home-based, wireless connection network, a first, home-based wireless communication plan is selected for the mobile communication device (i.e., the home-based wireless plan is placed into effect or is kept in force).

At decision block 72, the auto-provisioning software application 44 monitors whether the mobile communication device is still in a communication mode (e.g., the user continues to speak or send/receive text messages), or if the user has terminated the communication session, at step 74. If the user continues to maintain a communication link, at decision block 72, the process periodically returns to step 66 and decision block 68. At this step, the geographic location of the mobile communication device is updated, and the auto-provisioning software application 44 makes inquiries as to whether the mobile communication device is still in the wireless communication network A 14. If the mobile communication device continues to operate in the home service area of the wireless communication plan A 16, the auto-provisioning software application 44 may allow the mobile communication device to continue accessing the wireless communication network A 14.

On the other hand, if the user has moved from the wireless communication network A 14 to the geographic area serviced by another network, such as the wireless communication network B 32, for example, as indicated by translation arrow 40, the mobile communication device may attempt to gain access to the wireless communication network B 32 so as to maintain a communication mode. At this time, the geographic determination at decision block 68 will be indicating that the mobile communication device is no longer in home service area of the wireless communication network A 14. That is, when the mobile communication device is determined to be out of the first, home-based, wireless connection network, a second, roaming wireless communication plan may be placed into effect, depending upon whether pre-established authorization has been previously granted, as described in greater detail below.

In an exemplary embodiment, a pre-established authorization may comprise a roaming plan previously authorized and added to be effective as of the date that the user is expected to be travelling, so that an appropriate wireless communication plan is already activated. It should be understood that, an administrative policy may require a pre-authorization, or may not require a pre-authorization. If authorization is not needed for a requested wireless communication plan change, then the auto-provisioning software application 44 may add an appropriate wireless communication plan as needed. Otherwise, the procedure is to first request authorization, as described in greater detail below.

Accordingly, the MDM agent 28 may notify the auto-provisioning software application 44 of the roaming situation, at step 76. The auto-provisioning software application 44 may initiate a request to the wireless provider to change the wireless communication plan, the request being made via e-mail, through texting, or by accessing the web portal of the wireless communication provider. This change request may be made, for example, to authorize access to the wireless communication network B 32, at step 78. If pre-established authorization is provided to increase the communication capabilities of the mobile communication device by modifying, changing, or expanding the wireless communication plan A 16, at decision block 80, or if authorization was not required for the particular user, the process continues to step 70.

If no pre-established authorization is provided, at decision block 80, the auto-provisioning software application 44 may send an e-mail request for an ad hoc plan change to a local provider customer support agent, and may also manage any e-mail communications from the customer support agent on the corresponding e-mail thread. Alternatively, the auto-provisioning software application 44 may log into the web portal of the wireless provider and perform the required changes to the wireless communication plan. Preferably, the auto-provisioning software application 44 may initiate an ‘online chat’ with the customer support agent through the online portal of the wireless carrier. The auto-provisioning software application 44 may answer security and other questions asked by the customer support agent, so as to authorize the customer support agent to make the requested plan change for the mobile communication device, at decision block 82. This ad hoc plan change may also require approval of a supervisor of the employee, which approval may be obtained by e-mail, by chat, or by SMS, for example.

The auto-provisioning software application 44 may determine whether the requested change has been made by: (i) checking the online web portal to verify that the requested plan (e.g., wireless communication plan B1 46 or wireless communication plan B2 48) is effective for the mobile communication device being used, and/or (ii) confirming, via confirmation e-mail from the customer support agent that the plan change (e.g., to wireless communication plan B1 46 or to wireless communication plan B2 48) has been made as requested. If the customer support response e-mail is not a confirmation but rather requests additional information, an administrator or supervisor may then be alerted by a subsequent e-mail, by chat, or via Short Message Service (SMS), for assistance in providing the requested information. The auto-provisioning software application 44 can relay the requested information from the administrator back to the customer support agent.

If no pre-established or ad hoc authorization is granted, at decision block 82, the auto-provisioning software application 44 may act to block roaming activity on the mobile communication device for a predetermined period of time, at step 84. After the predetermined period of time, the auto-provisioning software application 44 may check to determine whether the mobile communication device has re-entered the home service area served by the wireless communication plan A 16, at decision block 86. Alternatively, the auto-provisioning software application 44 may be notified by the MDM agent 28 of a relevant change in geographic location of the mobile communication device. In either case, if the mobile communication device has returned to the wireless communication network A 14, then the process continues to step 70. Otherwise, the process returns to step 78 where the auto-provisioning software application 44 again attempts to modify, change, or expand the wireless communication plan A 16.

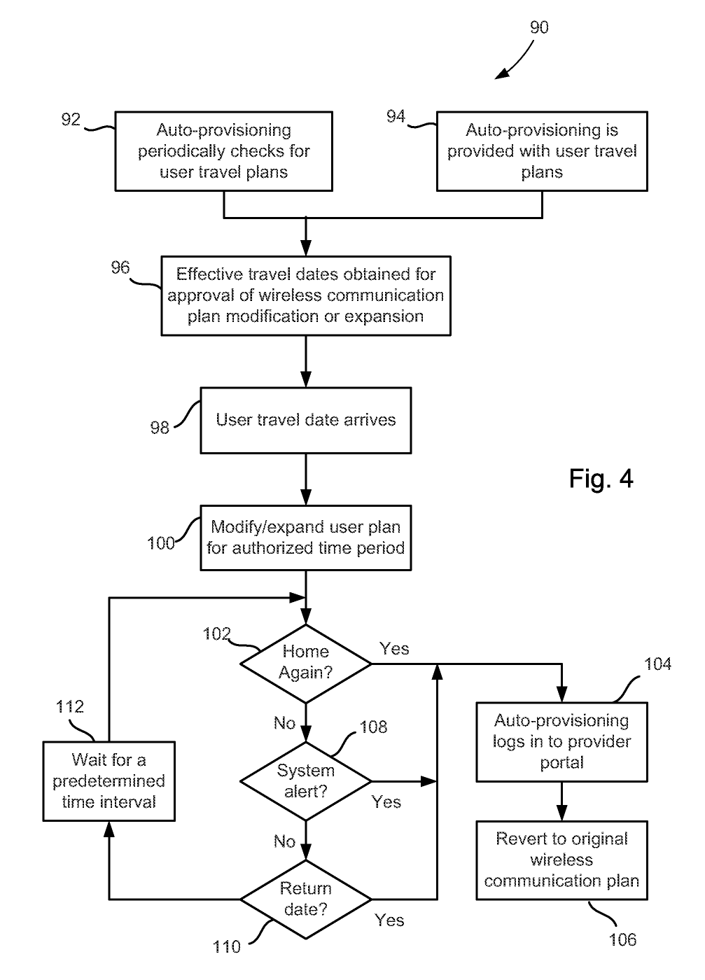

In an exemplary embodiment, the auto-provisioning software application 44 may periodically check for possible travel plans for the user of the mobile communication device, at step 92 of flow diagram 90, shown in FIG. 4. Alternatively, travel plan information can be provided to the auto-provisioning software application 44, at step 94. In another embodiment of the invention, a user or an administrator may notify the system about upcoming international travel dates. This could be done either through a web interface, an email interface, or through SMS, for example.

When this notification is received by the auto-provisioning software application 44, the auto-provisioning software application 44 may send an e-mail to the wireless provider requesting that an international data add-on, for example, should be added to the wireless communication plan A 16 on the specified date, and removed when the user of the mobile wireless device is expected to return to the home service area of the wireless communication plan A 16. The auto-provisioning software application 44 may then compute travel dates, including the expected date of departure and the expected date of return, at step 96.

Preferably, if the user of the mobile communication device plans to be outside the wireless communication network A 14 on a Monday, the auto-provisioning software application 44 may plan to modify or expand the wireless communication plan A 16 on, for example, the previous Thursday or Friday. This pro-active action allows for considering alternative options, such as contacting the customer support agent or alerting an administrator via e-mail, chat, or other means, should the requested wireless communication plan modification or expansion not come into effect as expected.

When the expected travel date for the user of the mobile communication device has arrived, at step 98, the wireless communication plan A 16 may be modified or expanded for the predetermined period of time by, for example, authorizing international roaming voice, data and messaging add-ons, at step 100. Once the user of the mobile communication device has returned to the home service area of the wireless communication plan A 16, at decision block 102, the auto-provisioning software application 44 may automatically log into the wireless provider portal, at step 104, and remove the previously-authorized international roaming add-ons, at step 106. This action will prevent the user of the mobile communication device 12 from continuously being charged for the extra services.

The auto-provisioning software application 44 may alternatively check the online wireless portal for call data records (CDRs) in the unbilled usage data, or perform web scraping, to determine if the mobile communication device has returned to the home service area of the wireless communication plan A 16, at step 102. If such a determination cannot be made, the auto-provisioning software application 44 may be alerted that the user of the mobile communication device has returned to the home calling area, at step 108. If an alert has been received, the process may go to step 104.

If no such alert has been received by the auto-provisioning software application 44, the process continues to decision block 110 where an inquiry is made as to whether the expected return date has been reached. If so, the process moves to step 104 for the wireless provider portal log in. The auto-provisioning software application 44 may schedule removal of any roaming plan by adding a buffer of zero or more days to the date of return of the user as per the documented travel plan. Otherwise, the auto-provisioning software application 44 waits for a predetermined amount of time, at step 112, and an inquiry is again made, at decision block 102, as to whether the mobile communication device is in the home service area of the wireless communication plan A 16.

In an exemplary embodiment, the auto-provisioning software application 44 may determine that the user of the mobile communication device has exceeded, or is about to exceed, an allotted quota of minutes, data, or messaging activity. In such cases, the auto-provisioning software application 44 may automatically provision a higher allowance plan that would cover the increased usage, and may also make the plan retroactive to the start of a current billing cycle. In an exemplary embodiment, the auto-provisioning software application 44 may log into the provider online account and purchase extra minutes, extra data capacity, or additional SMS resources, for the current month or billing cycle, if the user of the mobile communication device is close to using up a cell phone minute, data, or SMS quota for the month or billing cycle.

Alternatively, the auto-provisioning software application 44 may not act until closer to the billing cycle end date before determining and automatically provisioning a higher allowance plan. This delay in action may provide the auto-provisioning software application 44 with more information to make a determination of allowance of coverage in the entire billing cycle. Alternatively, the auto-provisioning software application 44 may operate to predict usage activity for a subsequent month based on the cumulative usage in the current billing cycle, and may then initiate wireless communication plan changes accordingly.

In an exemplary embodiment, the auto-provisioning software application 44 may determine that the user of the mobile communication device is using fewer minute/data/messages in comparison to the monthly allotment, the auto-provisioning software application 44 may automatically provision a less-expensive, lower allowance wireless plan, and make the change in wireless plan effective as soon as the wireless provider policy may allow, usually from the date of making the change or from the start of the next billing cycle.

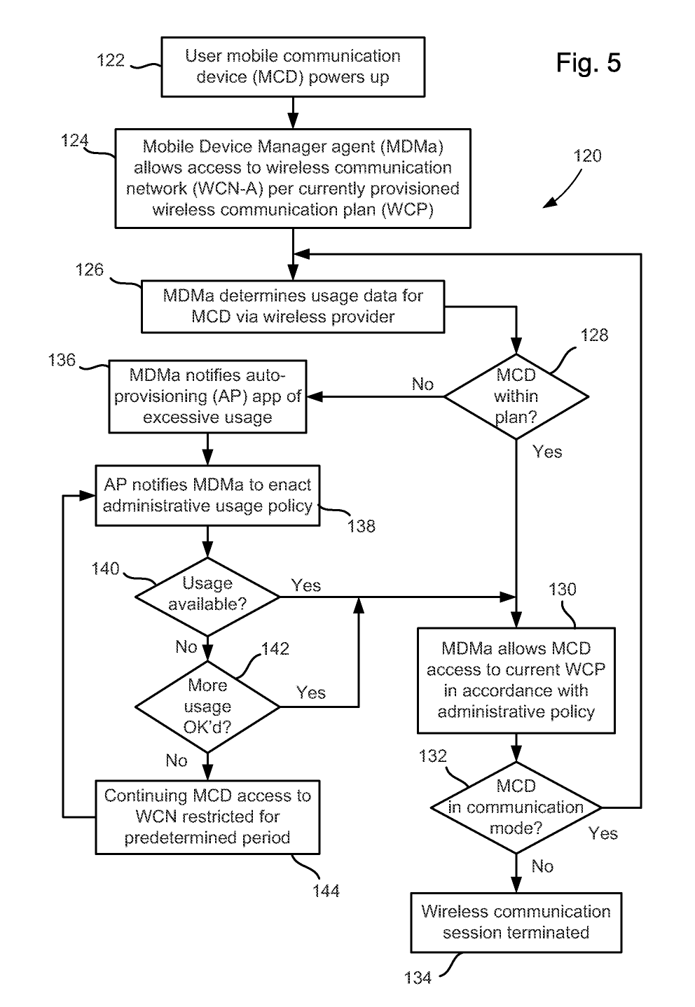

An alternative, exemplary embodiment of a user operation of the mobile communication devices 12, 52, can be described with reference to a flow diagram 120, shown in FIG. 5. The user powers up the mobile communication device, at step 122, and the mobile communication device connects to the Wireless Communication Network A 14 in accordance with the current wireless communication plan A 16, at step 124.

The current, usage data (e.g., voice communication, texting, SMS) is determined, at step 126, by accessing the MDM agent 28. If the usage data indicates that the usage of the mobile communication device is within the current wireless communication plan, at decision block 128, the MDM agent allows the mobile communication device to continue accessing the current wireless communication plan, at step 130.

At decision block 132, the auto-provisioning software application 44 monitors whether the mobile communication device is still in a communication mode (e.g., the user continues to speak or send/receive text messages), or if the user has terminated the communication session, at step 134. If the user continues to maintain a communication link, at decision block 132, the process periodically returns to step 126 and decision block 128. At this step, the usage data of the mobile communication device is updated. If the mobile communication device continues to operate within the current wireless communication plan A 16, the auto-provisioning software application 44 may allow the mobile communication device to continue accessing the wireless communication network A 14.

On the other hand, if excessive usage is detected, at decision block 128, the MDM agent 28 acts to notify the auto-provisioning software application 44, at step 136. The auto-provisioning software application 44 may initiate a request to the wireless provider to change the wireless communication plan to a wireless communication plan that provides a greater usage capacity, the request being made via e-mail, through texting, or by accessing the web portal of the wireless communication provider. If pre-established authorization is provided to increase the usage of the mobile communication device by modifying, changing, or expanding the wireless communication plan A 16, at decision block 140, or if authorization was not required for the particular user, the process continues to step 130.

If no pre-established authorization is provided, at decision block 140, the auto-provisioning software application 44 may send an e-mail request for an ad hoc plan change to a local provider customer support agent, and may also manage any e-mail communications from the customer support agent on the corresponding e-mail thread. Alternatively, the auto-provisioning software application 44 may log into the web portal of the wireless provider and perform the required changes to the wireless communication plan.

Preferably, the auto-provisioning software application 44 may initiate an ‘online chat’ with the customer support agent through the online portal of the wireless carrier. The auto-provisioning software application 44 may answer security and other questions asked by the customer support agent, so as to authorize the customer support agent to make the requested plan change for the mobile communication device, at decision block 142. This ad hoc plan change may also require approval of a supervisor of the employee, which approval may be obtained by e-mail, by chat, or by SMS, for example.

The auto-provisioning software application 44 may determine whether the requested change has been made by: (i) checking the online web portal to verify that the requested plan is effective for the mobile communication device being used, and/or (ii) confirming, via confirmation e-mail from the customer support agent that the plan change (e.g., to increase usage allotted to the wireless communication device) has been made as requested. If the customer support response e-mail is not a confirmation but rather requests additional information, an administrator or supervisor may then be alerted by a subsequent e-mail, by chat, or via Short Message Service, for assistance in providing the requested information. The auto-provisioning software application 44 can relay the requested information from the administrator back to the customer support agent.

If no pre-established or ad hoc authorization is granted, at decision block 142, the auto-provisioning software application 44 may act to block user activity on the mobile communication device for a predetermined period of time, at step 144, and the process returns to step 138 where the auto-provisioning software application 44 again attempts to modify, change, or expand usage for the mobile communication device.

In an alternative exemplary embodiment, a system may be provided by which a user of the mobile communication device may provide credentials for an online account at the wireless provider's website, using the web, mobile, or any other interface. A data fetching module may log into the wireless provider website account for the user, and download the current and past usage data for Minutes (calls made and received, total number of minutes, etc.), SMS (no. of SMS sent and received), and Data (typically provided in megabytes/kilobytes) along with the timestamps as to when the usage occurred. In an exemplary embodiment, this usage data may be scraped from the webpage directly from HTML. In another exemplary embodiment, the usage data may be downloaded as a formatted (i.e., structured) format, such as a Microsoft Excel file or a CSV (comma separated value) file. It can be appreciated that the fetching of usage data in this method contrasts with a method of downloading full-fledged bills from the wireless provider's website.

In an exemplary embodiment of the system, an analytics module may be used to tag all phone numbers called, and received calls from, and all the numbers with which SMS were exchanged with the wireless provider for that number. For example, the analytics module may tag one of the numbers as an AT&T number, and another number as a Verizon Wireless number. The system may fetch information about the “phone number to provider” mapping from third party sources of that information. Thereafter, the system may perform a provider-by-provider calls analysis based on the fact that most wireless communication plans allow calls between two numbers from the same provider at no charge. For example, calls between two AT&T wireless numbers are free to the users.

Also, some providers have plans where SMS between numbers of the same provider are free, or are reduced in cost. The analytics module may perform a “what-if” scenario, wherein a computation is made of the average peak minutes that would have been used in the last N months (e.g., six months), if the user's provider was AT&T wireless. The analytics module may compare the peak minutes against the plans that AT&T has, and estimates the costs that would have been if the user had been with AT&T for the last N months.

Similarly, the analytics module may run the analysis assuming that the user's provider was T-Mobile, and so on and so forth for all the other providers. The user is presented the results of this provider-by-provider analysis in a tabular and graphical format enabling the user to decide if it makes sense to switch wireless providers. A side-effect of this analysis is that the system will also report to the user facts such as breakdown of top ten most frequent calls by wireless provider, and may provide a breakdown of total minutes used per wireless provider.

In an exemplary embodiment, the system may comprise server software with a web interface, a data fetching module, a data analysis module, and a reporting module. A parent of a child user of the mobile communication device may use the web interface to create an account on the system and to give information to the system about the mobile communication device(s) of his children intended for monitoring. This information provided to the system includes the credentials of the online account at the wireless provider website that displays the usage information of the mobile communication devices.

The system may use this information to log into the wireless provider account on behalf of the parent, and fetch the usage data that is posted at the wireless provider online account. The usage data may be on an HTML web page, or it may be provided for download as CSV file, an MS Excel file, or in another format. Further, the usage data comprises historical usage data for past months as well as usage data for the current month. This usage data is continuously being updated as a mobile communication device is being used. After fetching the usage data, the system may log out of the wireless provider online account, and may transmit the acquired data to an analysis module.

In an exemplary embodiment, the parents can set a maximum limit (that is, alert threshold) for the number of SMS sent in the month, or sent daily or sent during school hours. If the usage exceeds the specified threshold, then the system may notify the parents using their chosen alerting mechanism. It can be appreciated that these alert thresholds/limits do not prevent children from sending SMS once the threshold is reached. Rather, the system may alerts the parents (and/or the child) that the daily or daytime or monthly quota set by the parents has been reached. Accordingly, it is desirable that the child may continue to send important SMS, even after a prescribed quota has been reached. This may prove to be highly advantageous in an emergency situation.

It is to be understood that the description herein is exemplary of the invention only and is intended to provide an overview for the understanding of the nature and character of the invention as it is defined by the claims. The accompanying drawings are included to provide a further understanding of various features and embodiments of the method and apparatus of the invention which, together with their description serve to explain the principles and operation of the invention.

Thus, as stated above, while the invention has been described with reference to particular embodiments, it will be understood that the present invention is by no means limited to the particular constructions and methods herein disclosed and/or shown in the drawings, but also comprises any modifications or equivalents within the scope of the claims. Further, the purpose of the Abstract is to enable the U.S. Patent and Trademark Office, the public generally, and in particular practitioners in the art who are not familiar with patent or legal terms or phraseology, to determine from a cursory inspection the nature and essence of the technical disclosure of the application. Accordingly, the Abstract is not intended to define nor limit the claims in any way.

What is claimed is:

1. A method for tracking a wireless communication plan and plan usage to control access costs for a mobile communication device having a resident mobile device management agent, said method comprising the steps of:
determining a geographic location for the mobile communication device;
if said geographic location is determined to be in a first wireless connection network, automatically provisioning a first wireless communication plan for the mobile communication device; and
if said geographic location is determined to be in a second wireless connection network, automatically provisioning a second wireless communication plan for the mobile communication device.

2. The method of claim 1 further comprising the steps of:
determining, after a pre-determined amount of time, an updated geographic location for the mobile communication device;
if said updated geographic location is determined to be in said first wireless connection network, provisioning said first wireless communication plan for the mobile communication device; and
if said updated geographic location is determined to be in said second wireless connection network, provisioning said second wireless communication plan for the mobile communication device.

3. The method of claim 1 wherein said step of determining said geographic location comprises the step of determining geographic coordinates for said mobile communication device by at least one of: accessing a global positioning system, using a database of cellular towers to determine device location, or obtaining device location from the provider of the wireless communication system linked to the mobile communication device.

4. The method of claim 1 wherein said step of selecting said second wireless communication plan comprises the steps of:
if authorization is not required to modify a wireless communication plan, selecting said second wireless communication plan;
if pre-authorization is required to modify a wireless communication plan, seeking pre-established authorization for selecting said second wireless communication plan;
If said pre-established authorization is granted, placing said second wireless communication plan into effect; and
If said pre-established authorization is not granted, keeping said first wireless communication plan in force.

5. The method of claim 1 further comprising the step of, if said pre-established authorization is not available, contacting an administrator to obtain ad hoc authorization for placing said second wireless communication plan into effect.

6. The method of claim 5 wherein said step of contacting comprises at least one of sending an e-mail, engaging in chat, or using Short Message Service.

7. The method of claim 1 further comprising the step of, if said pre-established authorization is not available, contacting an administrator to obtain ad hoc authorization for placing a third wireless communication plan into effect.

8. The method of claim 1 further comprising the step of, if said pre-established authorization is not granted, directing the mobile device management agent to suspend access to said second wireless communication plan for a predetermined amount of time.

9. The method of claim 1 further comprising the steps of:
if a user of the mobile communication device has exceeded, or is about to exceed, an allotted quota of minutes, data, or messaging activity;
provisioning a higher-allowance plan to cover increased usage of the mobile communication device.

10. The method of claim 1 further comprising the steps of:
if a user of the mobile communication device is close to using up at least one of a wireless, data, or Short Message Service usage quota for a current billing cycle;
logging into a wireless provider online account and purchasing additional wireless, data, or Short Message Service usage for said current billing cycle.

11. A mobile communication device that functions to continually track a wireless communication plan and plan usage, said mobile communication device comprising:
a mobile device management agent, said mobile device management agent functioning to perform at least one of: controlling access between said mobile communication device and a wireless communication network, collecting geographic data by accessing a global positioning system, and by acquiring usage data for said mobile communication device;
an application programming interface in communication with said mobile management agent; and
an auto-provisioning software application in communication with said mobile management agent via said application programming interface for provisioning a wireless communication plan for the wireless communication device based on at least one of a real-time geographic location of said mobile communication device and a current usage history for said mobile communication device.

12. The mobile communication device of claim 11 wherein said mobile device management agent functions to access at least one of a global positioning system and a wireless cellular network to determine said real-time geographic location of said mobile communication device.

13. The mobile communication device of claim 11 wherein said auto-provisioning software application is resident in at least one of said mobile communication device and a remote monitoring server.

14. A computer product, tangibly embodied in a non-transitory computer-readable medium, for tracking a wireless communication plan to control access costs for a mobile communication device, said computer program product including instructions for causing a processor to execute a method comprising the steps of:
detecting the mobile communication device;
accessing a global positioning system to determine a real-time geographic location for the mobile communication device;
if said geographic location is determined to be in a first wireless connection network, selecting a first wireless communication plan for the mobile communication device; and
if said geographic location is determined to be in a second wireless connection network, selecting a second wireless communication plan for the mobile communication device.

15. The computer product of claim 14 wherein said method further comprises the step of selecting a wireless communication plan for the mobile communication device, said step of selecting based on said real-time geographical location.
